(19) United States
(12) Patent Application Publication
(10) Pub. No.: US 2025/0365464 A1
(43) Pub. Date: Nov. 27, 2025

(54) MULTI-BAND MULTI-STANDARD MEDIA RECEIVER SYSTEM AND METHOD OF ‘ON DEMAND FEATURE’ ACTIVATION

(71) Applicant: Harman Becker Automotive Systems GmbH, Karlsbad-Ittersbach (DE)

(72) Inventor: Karl-Anton Becker, Karlsbad (DE)

(21) Appl. No.: 19/190,407

(22) Filed: Apr. 25, 2025

(30) Foreign Application Priority Data
May 21, 2024 (EP) 24177121

(51) Int. Cl. H04N 21/426

(52) U.S. Cl. CPC H04N 21/426

(57) ABSTRACT

The invention relates to a method for configuring a re-configurable multi-band multi-standard media receiver and a multi-band multi-standard reconfigurable media receiver. The media receiver comprises a controller configured to control hardware components and software components of the media receiver, the method comprising selecting one or more features on demand (FoD) of the multi-band multi-standard re-configurable media receiver, and configuring the re-configurable media receiver based on the selected one or more FoD.

### CROSS REFERENCE TO RELATED APPLICATIONS

The present application claims priority to European Patent Application No. 24177121.1, entitled “MULTI-BAND MULTI-STANDARD MEDIA RECEIVER SYSTEM AND METHOD OF ‘ON DEMAND FEATURE’ ACTIVATION”, and filed on May 21, 2024. The entire contents of the above-listed application is hereby incorporated by reference for all purposes.

### BACKGROUND OF THE INVENTION

Features-on-demand (FoD) are opening up a new era of growth for many industries and automotive industry is not an exception. In an ever-changing and fast paced world, customers expectations are constantly changing. Original equipment manufacturers (OEM s) and their suppliers are under tremendous pressure to cope with this disruption. They and their supply chain partners are coming up with innovative ways to break new ground and avail new business opportunities. As a result, FoD is not only attractive to OEM's, but also for suppliers in their supply chain. In order to succeed, both OEM s and their suppliers will have to develop and launch a wide range of processes along the value chain, while at the same time they must navigate and master the associated challenges.

From an OEM perspective, the complexity begins with incorporating the correct prerequisites for FoD including fully featured vehicle production, forming new cooperation models with their supply chain partners, navigating through regulatory requirements for new features, and establishment of cyber security and software update management systems to name a few.

In the context of broadcast radio/TV information solutions (for example, in vehicles), different broadcast requirements for different markets, territories and target groups have so far required several different hardware variants. In different market regions different statutory requirements apply. This means that further hardware variants must be available for different regions. For example, a vehicle built and destined for a first location may only be built with the hardware components required to meet broadcast requirements of that first location. Therefore, a radio of that vehicle may struggle to efficiently receive broadcast signals when the vehicle is located outside of the first location. At the same time,

However, a variety of hardware variants mean additional logistical effort and additional development and manufacture costs. To satisfy a diverse group of customers and their requirements, an all-in-one solution could be implemented, that would include all of the hardware variants. However, OEM customers demand continuous cost optimization while maintaining 100% customer satisfaction and implementing all of the hardware variants would be the most expensive solution that most customers are not willing to pay. It is thus an object of the invention to provide a multi-band multi-standard media receiver that incorporates fewer hardware components and that can receive broadcast signals from a variety of territories. It is a further object of the invention to provides an enhanced experience to the end-user to seamlessly receive broadcasts in a variety of territories at a reduced cost.

### SUMMARY

To achieve the above objectives, the invention sets out a method and a multi-band multi-standard re-configurable media receiver as set out herein.

In an embodiment, a method for configuring a re-configurable multi-band multi-standard media receiver is set out. The media receiver comprises a controller configured to control hardware components and software components of the media receiver. The method comprises selecting one or more features on demand (FoD) of the multi-band multi-standard re-configurable media receiver, and configuring the re-configurable media receiver based on the selected one or more FoD.

In an embodiment, configuring the re-configurable media receiver based on the selected one or more FoD comprises activating the selected one or more features of the re-configurable multi-band multi-standard media receiver, wherein activating the selected one or more features comprises activating a software component and/or a hardware component of the media receiver.

In an embodiment, a hardware component of the media receiver comprises one or more antennae, one or more radio tuners, one or more TV tuners, and/or one or more digitizers. In an embodiment, a software component of the media receiver comprises one or more radio standards, at least one service on demand (SoD), an application programming interface (API) a program, and/or an algorithm.

In an embodiment, a FoD comprises a multistandard radio standard, a multiband digital radio standard, antenna diversity, multi tuner, AM noise reduction for EVs, a station list update, seamless linking, seamless blending, and/or beam forming.

In an embodiment, the multi-band multi-standard media receiver comprises a software-defined radio algorithm (SDR) and the method further comprises receiving, by the SDR, a hybrid signal comprising a digital broadcast signal and an analog broadcast signal, determining, by the SDR, quantitative properties of the digital broadcast signal and the analog broadcast signal, selecting, by the SDR, one of the digital broadcast signal and the analog broadcast signal based on the quantitative properties, and subsequently selecting, by the SDR, the other one of the digital broadcast signal and the analog broadcast signal when the quantitative properties are reversed.

In an embodiment, the quantitative properties comprise a signal quality, a signal strength, a signal frequency property, detection of the presence of a digital signal, and/or detection of the presence of an analog signal.

In an embodiment, selecting and subsequently selecting the digital broadcast signal and the analog broadcast signal comprises switching between the broadcast signals via seamless linking or seamless blending.

In an embodiment, selecting a FoD comprises: presenting one or more FoD for selecting in a user interface of the media receiver.

In an embodiment, the method further comprises detecting a location of the multi-band multi-standard media receiver, determining at least one condition required by the location of the multi-band multi-standard media receiver to activate one or more FoD, and selecting the one or more FoD of the multi-band multi-standard media receiver that meet the at least one condition required by the location of the multi-band multi-standard media receiver.

In an embodiment, the selected FoD is acquired for a predetermined period of time and the method further comprises deactivating the selected one or more features of the re-configurable multi-band multi-standard media receiver, re-activating the selected one or more features of the re-configurable multi-band multi-standard media receiver within the predetermined period of time, and preventing re-activation of the selected one or more features of the re-configurable multi-band multi-standard media receiver outside of the predetermined period of time.

In an embodiment, the predetermined period of time is a finite period of time or an unlimited period of time.

In an embodiment, a multi-band multi-standard re-configurable media receiver comprises a controller configured to control hardware components and/or software components of the multi-band multi-standard media receiver, wherein the controller is configured to receive a selection of one or more features on demand, FoD, and configure the re-configurable media receiver based on the selected one or more FoD.

In an embodiment, the controller is configured to activate one or more features of the re-configurable multi-band multi-standard media receiver, by activating hardware components and/or software components of the media receiver.

In an embodiment, the media receiver comprises a global navigation satellite system, GNSS, receiver operable to detect a location of the multi-band multi-standard media receiver, and a FoD is selected depending the location of the media receiver.

In an embodiment, the media receiver further comprises a software-defined radio algorithm (SDR) and/or the controller is implemented as a software; and the controller comprises a processor operable to execute the SDR and/or the controller software.

In an embodiment, the media receiver further comprises a display unit, wherein the controller is configured to present FoDs on the display unit for selecting.

In an embodiment, the controller is configured to carry out the method as set out above.

### BRIEF DESCRIPTION OF THE DRAWINGS

FIG. 1 shows a block diagram of a multi-band multi-standard media receiver with a tuner part and a controller part being in one entity;

FIG. 2 shows a block diagram of a multi-band multi-standard media receiver with a tuner part and a controller part being separate entities;

FIG. 3 shows a block diagram of an embodiment of a multi-band multi-standard media receiver with a tuner part and a controller part being separate entities with a display and a server unit;

FIG. 4 shows a block diagram of a method according to an embodiment; and

FIG. 5 shows a block diagram of a method according to another embodiment.

### DETAILED DESCRIPTION OF EMBODIMENTS

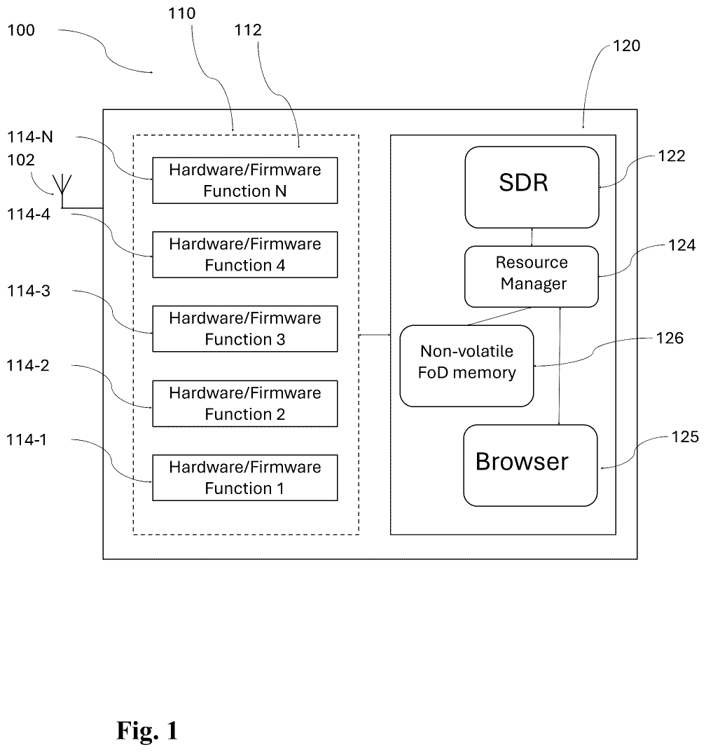

FIG. 1 shows a multi-band multi-standard re-configurable media receiver 100 (as a part of an infotainment system) comprising a tuner part 110 and a controller part 120. The radio and/or TV tuner part 110 is connected to at least one antenna 102. Although not shown, there may be several antennas, wherein the antennas may be configured to receive different radio signals, for example one or more signals from AM, FM or DAB/DMB or DVB, which are broadcasted on different frequencies. A multi-band multi-standard reconfigurable media receiver (herein also referred to as a ‘media receiver’, a ‘reconfigurable media receiver’ or a ‘multi-band multi-standard media receiver’) is a media receiver or infotainment solution that can be configured to receive radio, TV, cellular networks (such as, but not limited to, 5G, 6G and other suitable cellular networks) and other broadcasts in multiple bandwidth ranges (as described below) and can receive broadcasts in multiple standards (as described below).

The radio tuner part comprises a radio tuner frontend 112, which comprises several hardware and software/firmware defined functions 114-1 to 114-N. These functions may be components, for example, different tuner components such as LNAs, signal splitters, RF switches, mixers, filters, analog to digital converters (ADC), or the use of application programming interfaces (A Pls). For the invention it is beneficial if the tuner part 110 comprises all hardware necessary for all features.

The controller part 120 may be configured to activate or deactivate any one of the hardware and software/firmware defined functions 114-1 to 114-N. The controller part 120 may comprise a software defined radio algorithm (SDR) 122, an internet browser 125 and a resource-manager 124 (which may be a controller and/or which may be software implemented) which configures hardware and software components, controls the signal flow and so activates the different features, e.g. foreground/background use cases of the radio receiver 100. In some embodiments, the controller 120 may be implemented as software (which may be as an SDR and/or separate software). In some embodiments, the controller may comprise a processor operable to execute the SDR and/or the controller software.

A software-defined radio (SDR) is a radio communication system that utilizes software to perform many of the functions traditionally implemented in hardware. In an SDR system, the radio frequency (RF) signal is digitized using an analog-to-digital converter (ADC), and then processed by software running on a general-purpose computer or embedded system. The software that runs on the computer or embedded system defines the signal processing and the communication protocols that are used to transmit and receive data. The use of software in an SDR system allows for greater flexibility, reconfigurability, and scalability compared to traditional radio systems, which are typically implemented using hardware-based solutions.

This allows the SDR to be easily reconfigured to support different wireless communication standards, such as WiFi, Bluetooth, and cellular networks. After digitizing the radio signal all filters and other decoding procedures can be implemented as software. Hence the SDR can easily include all statutory requirements for any market without additional hardware costs.

The controller is configured to receive a selection of one or more features of a feature catalog (for example, features on demand (FoD) which are features that can be supported by the available hardware). The controller is further configured to select one or more features of the feature catalog, and to configure the re-configurable media receiver based on the selected one or more FoD.

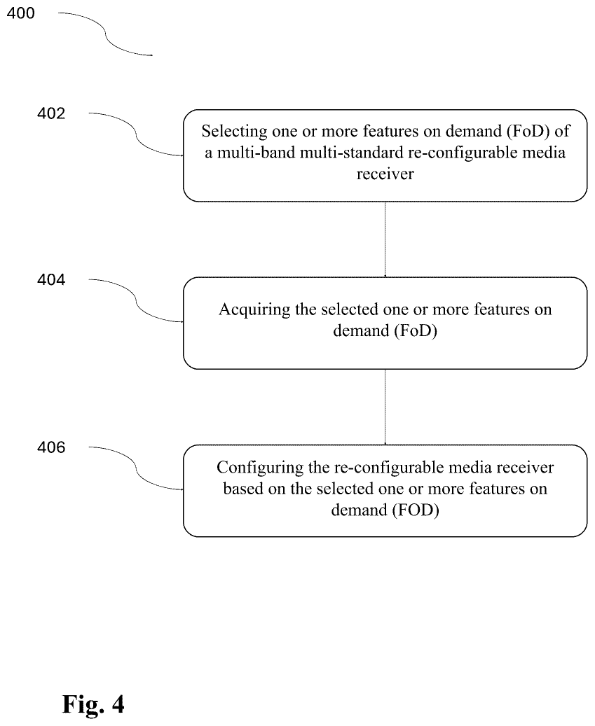

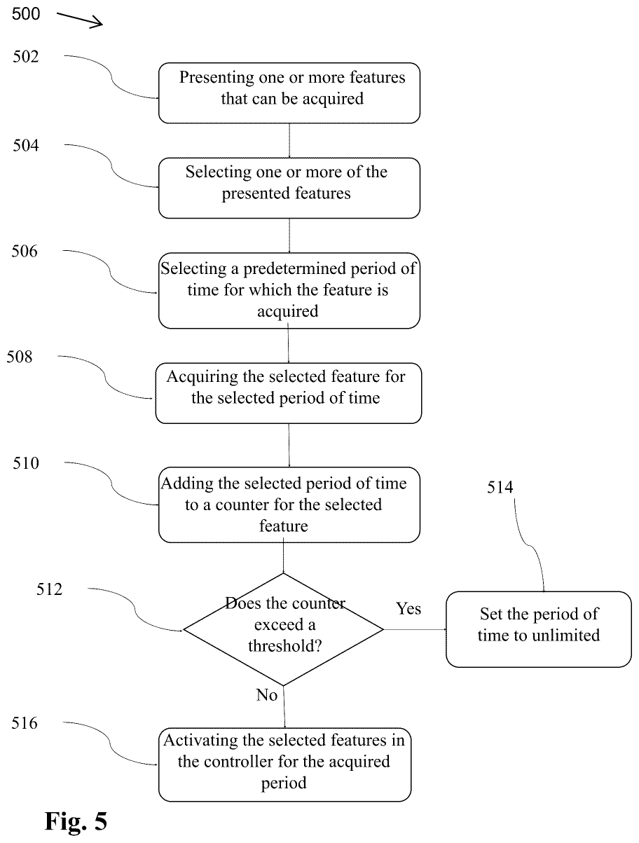

The controller may be configured to activate one or more features of the re-configurable multi-band multi-standard media receiver by activating hardware components and/or software components of the media receiver, such as hardware and software firmware defined functions 114-1 to 114-N based on the selected FoD. The controller may additionally be configured to acquire the selected FoD as is described below with reference to FIGS. 4 and 5.

In this example the SDR 122, the internet browser 125, the memory 126 and the resource manager 124 may be integrated within a single System on a Chip (SoC) or processor. Also in this example the tuner part 110 and the controller part 120 may be integrated within a single unit.

The media receiver may be coupled to or comprise a global navigation satellite system (GNSS) receiver (not shown). This GNSS receiver can be a unit that is part of the media receiver (for example, part of the controller part 120) or it may be a unit that is separate to the media receiver but that is in direct communication with the controller part 120 of the media receiver. The GNSS may be any suitable navigation satellite system including, but not limited to, NAVSTAR, GPS, GLONASS, Galileo, Beidou or the like. The GNSS receiver is operable to detect a location of the multi-band multi-standard media receiver (for example, a specific geographic location such as a specific address, a geographic zone such as a country or city, or an altitude of the media receiver). Depending on the detected location of the GNSS, the controller 120 can redefine which of the selection of one or more FoD are presented to the controller depending on whether they are supported in the current location or not. Accordingly, the GNSS may determine at least one condition required by the location of the multi-band multi-standard media receiver to activate one or more features (FoD).

The controller 120 can then select the one or more supported FoD of the multi-band multi-standard media receiver that meet the at least one condition required by the location of the multi-band multi-standard media receiver (i.e., depending on the location of the media receiver). This is advantageous when a vehicle (or any other device) comprising the media receiver is transported from an area or zone with one set of requirements (such as receiving radio broadcasts in 50 kHz increments) to a different area or zone (such as receiving radio broadcasts in 100 kHz increments). In such scenarios, when the location is detected, seamless transitioning can be provided based on the location to deactivate the receiving requirements of the previous location and activate the receiving requirements of the current location.

A hardware component or a hardware defined function of the media receiver as described above may comprise one or more antennae, one or more radio tuners, one or more TV tuners, and/or one or more digitizers. A software component or a software defined function of the media receiver as described above may comprise one or more radio standards, at least one service on demand (SoD), an application programming interface (API), a program, and/or an algorithm.

In some embodiments, the multi-band multi-standard re-configurable media receiver is a media receiver that is configured to receive broadcasts from cellular networks (such as, but not limited to, 5G, 6G and other suitable cellular networks). The media receiver configured to receive broadcasts from cellular networks may additionally comprise an API for easy design and integration of media services in existing applications and devices. Advantageously, such a media receiver does not require uplink or a SIM card and may be configured, by the API, to instead comprise a ‘receive-only mode’ and/or ‘free-to-air reception’. Such a media receiver may further comprise encrypted services including authentication mechanisms, at least one dedicated broadcast network (and related hardware and software infrastructure), single frequency networks (SFNs), fixed mobile reception, and portable mobile reception. The above list is non-exhaustive and the media receiver may comprise any additional hardware and software components suitable to transmit and/or receive cellular broadcast signals.

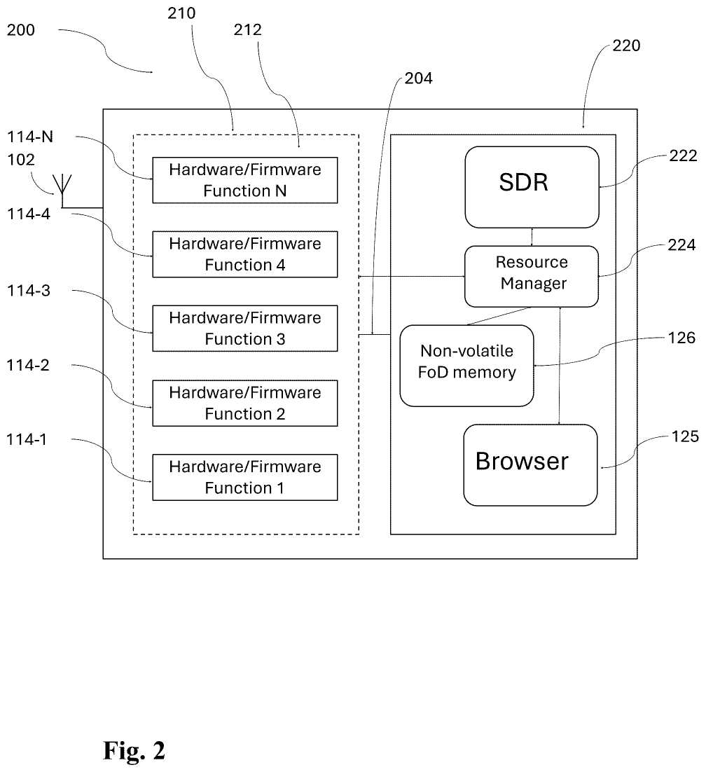

FIG. 2 shows another embodiment of a re-configurable multi-band multi-standard media receiver 200. In this embodiment, the radio and/or TV tuner part 210 comprises the radio tuner frontend 212 with the hardware and firmware/software defined functions 114-1 to 114-N. The controller part 220 comprises a SDR 222 and/or an internet browser 125, a non-volatile FoD memory 126 and a resource-manager 224 (which may be a controller and/or which may be software implemented) that are separated. The resource-manager 224 may be a software implemented in a SoC or integrated in a media center of a vehicle. The tuner part 210 and the controller part 220 are separate entities and are connected through a cable 204, which may be a common vehicle bus.

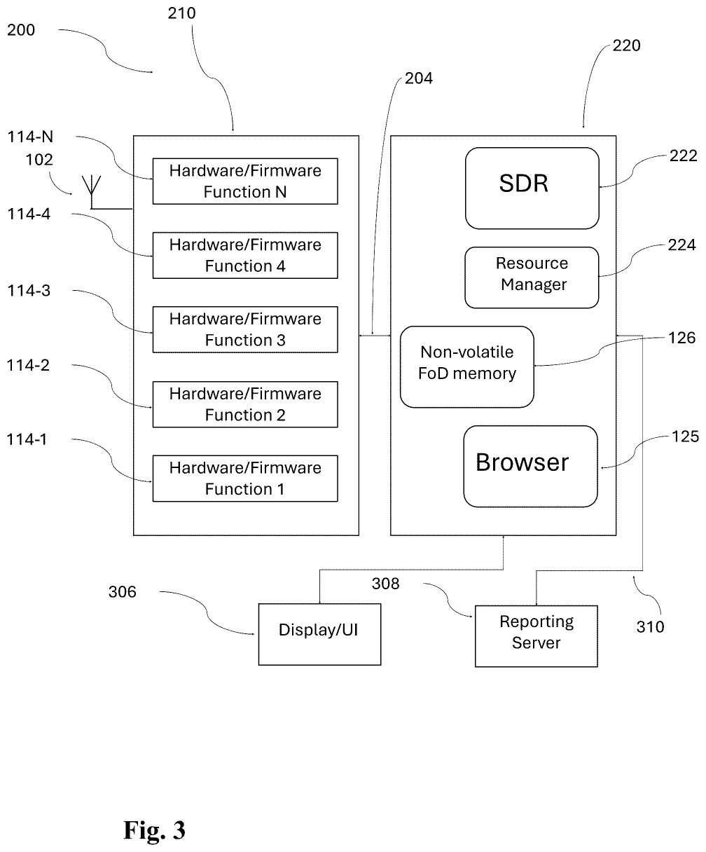

FIG. 3 shows a re-configurable multi-band multi-standard media receiver 200 similar to that of FIG. 2, additionally comprising a display unit 306, that is configured to display a user interface (such as a graphical user interface, GUI) of re-configurable multi-band multi-standard media receiver 200 and to present FoDs on the display unit 306 for selecting. FIG. 3 also shows a reporting server 308 that is coupled to the controller part 220 via for example a mobile radio connection 310.

FIG. 4 shows a flow diagram of a first method according to an embodiment for on demand activating features for the re-configurable multi-band multi-standard media receiver as described with reference to FIGS. 1 to 3 above.

Step 402 comprises selecting one or more features (for example, features on demand (FOD)) of the multi-band multi-standard re-configurable media receiver (for example, tuner hardware and/or of the SDR algorithm stack and/or of the internet browser). This selecting may be done by a customer or an OEM. For example, a set of features may be selected at the time the vehicle is purchased or ordered. Features also may be selected later during use of the vehicle. A feature in the sense of the invention can, for example, be a specific mode of the radio, a specific reception improvement algorithm, or a digital radio/TV decoder or an IP-Radio/TV/streaming device feature of the internet browser. A mode may be for example single antenna, single tuner; dual FM antenna, dual tuner; dual antenna, dual tuner, different radio standards AM, FM, HD-Radio, DRM, CDR, DAB, DMB, DVB, IP-Radio/TV . . . , foreground audio tuner or background tuner for band scan and data collection, announcement, warning functions or the like. A reception improvement feature (FoD) may comprise a multistandard radio standard, a multiband digital radio standard (which may include, but is not limited to, a digital shortwave radio standard (DRM)), any type of antenna diversity or beam forming methods, seamless linking and/or seamless blending to alternative frequencies or other content sources, noise reduction (for example, AM noise reduction for electric vehicles (EVs)) and signal concealment caused by bad reception conditions (e.g. multi path reception), by adjacent channels (for example, AM channels) or by electromagnetic interferers outside or inside of the fuel driven or electrical vehicle (EV). Comfort features (FoD) may be for example background station list, station list updates, station logos, radio text, program-accompanying slideshow and/or other metadata based and supplementary data features. Such comfort features (FoD) may provide an increase in ease of use for the user. A digital radio decoder feature may support the following standards DAB; DAB+; HD-R; CDR; DRM; DMB, DVB-T, ISDB-T, ATSCX. A browser feature may provide access to an IP-Radio/TV/streaming or podcast services. Several features can further be bundled to feature packs, that are selectable additionally or instead of single features.

In an embodiment, a further FoD may include receiving, by the SDR, a hybrid signal comprising a digital broadcast signal and an analog broadcast signal. Subsequently, the SDR may determine quantitative properties of the digital broadcast signal and the analog broadcast signal. The quantitative properties may comprise a signal quality, a signal strength, a signal frequency property, detection of the presence of a digital signal, detection of the presence of an analog signal and/or any other suitable signal parameters.

The SDR may subsequently selected one of the digital broadcast signal and the analog broadcast signal based on the quantitative properties (for example, it may select the broadcast signal with better signal strength). Subsequently, the SDR may selecting the other one of the digital broadcast signal and the analog broadcast signal when the quantitative properties are reversed. Selecting the digital broadcast signal and the analog broadcast signal may comprise switching between the broadcast signals via seamless linking or seamless blending. Seamless linking is a first type of transitioning method for transitioning between one signal to another signal in a specified bandwidth (for example, seamless linking can be applied in European broadcasting territories where the specified bandwidth may be 200 kHz). Seamless blending is a second type of transitioning method for transitioning between one signal to another signal in a different specified bandwidth (for example, seamless transitioning can be applied in US and/or North American broadcasting territories where the specified bandwidth may be 400 kHz).

Seamless blending and/or seamless linking from an analog signal to a digital signal (or from a digital signal to an analog signal) may be performed by a cross-fader which is part of the controller (as described above with reference to FIGS. 1 to 3). The blending/linking process may include diminishing the analog/digital signal output to a loudspeaker while increasing the respective digital/analog signal output to the loudspeaker smoothly at the same time. A listener may perceive little change in signal output as a result. The cross-fader may include volume and frequency compensation circuitry or logic, such as filters, Fourier transforms, amplifiers, comparators, frequency shifters, expanders, and other digital signal processing components. The following table shows an example of three feature packs, Entry, Medium/Advanced and Premium, that each comprise several features. The feature packs also differ for the targeted market. Additionally, all features may be individually selectable.

There may be less or more feature packs with different names, the feature packs may consist of different features and there may, in general, be additional or fewer features in one feature package. The invention is by no means limited to the shown features and/or feature packs.

| Level | | | |
|---|---|---|---|
| Market | | | |
| Baseline | | Medium/ | |
| feature set | Entry | Advanced | Premium |
| FoD | HW protection for additional Features On Demand | | |
| Preparation | | | |
| Market 1 | Feature 1 | Feature 1 | Feature 1 |
| | | Feature 2 | Feature 2 |
| | | | Feature 3 |
| Market 2 | Feature 1 | Feature 1 | Feature 1 |
| | | Feature 2 | Feature 2 |
| | | | Feature 3 |
| | Feature 4 | Feature 4 | Feature 4 |
| | | Feature 5 | Feature 5 |
| | | | Feature 6 |
| Market 3 | Feature 1 | Feature 1 | Feature 1 |
| | | Feature 2 | Feature 2 |
| | | | Feature 3 |
| | Feature 7 | Feature 7 | Feature 7 |
| | | Feature 8 | Feature 8 |
| | | | Feature 9 |
| Market n | Feature 1 | Feature 1 | Feature 1 |
| | | Feature 2 | Feature 2 |
| | | | Feature 3 |
| | Feature 7 | Feature 7 | Feature 7 |
| | Feature 10 | Feature 10 | Feature 10 |
| | | Feature 11 | Feature 11 |
| | | | Feature 12 |

One example of feature packs is provided in the table below to exemplify what each feature may comprise. The invention is not limited to these specific features and may comprise any number of features and feature packages.

| | Entry | Medium/Advanced | Premium |
|---|---|---|---|
| Level | (single antenna, single | (dual FM antenna, | (dual antennae, multi |
| Market | tuner) | multi tuner) | tuner) |
| Global Analog | AM + FM (single | AM + FM-Diversity | |
| Tuner | Antenna) | | |
| Baseline | RDS/RBDS PS, AF | | |
| FoD | HW protection for Premium Features On Demand *) | | |
| Preparation | | | |
| APAC/RoW | | FM Station List | FM Station List |
| Tuner package | | Update | Update |
| | AM noise reduction | AM Station List + | AM Station List + |
| | for EVs | AM noise reduction for | AM noise reduction for |
| | | EVs | EVs |
| NA | HD-Radio | HD-Radio | HD-Radio with Beam |
| Tuner package | | | Forming MRC- |
| | | | Diversity |
| | | HD-LOT and | HD-LOT and |
| | HD-Radio | secondary services | secondary services |
| | secondary services | FM + HD-R Station | FM + HD-R ultra fast |
| | | List Update | Station List Update |
| | AM noise reduction | AM Station List + | AM Station List + |
| | for EVs | AM noise reduction for | AM noise reduction for |
| | | EVs | EVs |
| EU/AU/GCC | DAB | DAB | DAB with NC-MRC |
| Tuner package | | | Diversity |
| | | DAB Data services | DAB Data services |
| | | (SLS) | (SLS) |
| | | FM + DAB BG | FM + DAB BG ultra |
| | | Station List Update! | fast Station List |
| | | | Update! |
| | Linking | Seamless linking | Seamless linking |
| | DAB<>DAB<>FM | DAB<>DAB<>FM | DAB<>DAB<>FM |
| | AM noise reduction | AM Station List + | AM Station List + |
| | for EVs | AM noise reduction for | AM noise reduction for |
| | | EVs | EVs |
| India | DRM30 | DRM30 | DRM30 |
| Tuner package | DRM+ | DRM+ | DRM+ with MRC |
| | | | Diversity |
| | | DRM Data Services | DRM Data Services |
| | | FM/DRM Station List | FM/DRM fast Station |
| | | Update | List Update |
| | AM noise reduction | AM Station List + | AM Station List + |
| | for EVs | AM noise reduction for | AM noise reduction for |
| | | EVs | EVs |
| South Africa, | DRM30 (AM-B and) | DRM30 | DRM30 |
| Indonesia, | DRM+ (FM-B and) | DRM+ | DRM+ with MRC |
| Australia | | | Diversity |
| Tuner package | DAB | DAB | DAB with MRC- |
| | | | Diversity |
| | | DRM, DAB Data | DRM, DAB Data |
| | | Services | Services |
| | | FM/DRM/DAB | FM/DRM/DAB ultra |
| | | Station List Update | fast Station List Update |
| | AM noise reduction | AM Station List + | AM Station List + |
| | for EVs | AM noise reduction for | AM noise reduction for |
| | | EVs | EVs |
| China | DRM30 | DRM30 | DRM30 |
| Tuner package | CDR | CDR | CDR with Beam |
| | | | Forming MRC- |
| | | | Diversity |
| | | CDR Data Services | CDR Data Services |
| | | FM/DRM/CDR | FM/DRM/CDR ultra |
| | | Station List Update | fast Station List Update |
| | AM noise reduction | AM Station List + | AM Station List + |
| | for EVs | AM noise reduction for | AM noise reduction for |
| | | EVs | EVs |
| International | AI supported Station | Seamless Linking | Seamless Linking |
| Online Radio | Selection | BC ><IP-Radio | BC ><IP-Radio |
| Package | Seamless Linking | Seamless Linking | Seamless Linking |
| | BC ><IP-Radio | BC ><IP-Radio | BC ><IP-Radio |
| | . . . | | |
| | . . . | | |

Step 404 comprises acquiring the selected features (FoD). Acquiring may activating and/or de-activating the selected FoD for a predetermined period of time. For example, acquiring may comprise deactivating the selected one or more features of the re-configurable multi-band multi-standard media receiver and re-activating the selected one or more features of the re-configurable multi-band multi-standard media receiver within the predetermined period of time. Acquiring may further comprise preventing re-activation of the selected one or more features of the re-configurable multi-band multi-standard media receiver outside of the predetermined period of time. The predetermined period of time may be a finite period of time, or an unlimited period of time. The acquiring may be handled via a pre-existing user account. The acquiring may be done at the time the vehicle is purchased and/or later during the use of the vehicle.

After selecting the one or more features on demand (FOD) at step 402, the method further comprises configuring the re-configurable media receiver based on the selected one or more FoD as defined in step 406. This has the benefit, that the whole driving experience is redefined. FoD allows owners to customize tuner functionality by adding new parts and functionalities through over-the-air (OTA) updates as an example. This provides increased personalization and customization features with a limited burden on hardware component requirements. Activating as set out in step 406 may comprise activating the selected one or more features of the re-configurable multi-band multi-standard media receiver, wherein activating the selected one or more features comprises activating the software component and/or a hardware component 114-1 o 114-N of the media receiver. Activating the selected feature may comprise enabling hardware in the tuner frontend part and/or enabling software parts of the SDR. In the same manner, features may be deactivated when the end of the predetermined period of time is reached.

FIG. 5 shows a flow diagram of a method that is complimentary the method of FIG. 4.

Step 502 comprises presenting one or more features that can be acquired for the SDR. Presenting may be for example a listing in a catalogue of the car manufacturer before a vehicle is purchased. Presenting may also be done in the vehicle during use. For this, for example the display unit 304 of FIG. 3 may be utilized. However, there may be other display means available in a specific car.

Step 504 comprises selecting of one or more of the presented features. The feature may be presented in a list or as feature packs as described above. Selecting a FoD may be done by presenting one or more FoD for selecting on a user interface (which may be a display unit or an audio system for presenting features) of the media receiver or before purchasing a vehicle. In some arrangements, it may be beneficial when features (FoD) are bundled in feature packages and the packages are presented for acquiring. The features may be bundled by an OEM that supplies the radio. Advantageously, the customer does not need to handle individual features. The selecting and acquiring may be done at the time the vehicle is purchased or ordered. Furthermore, a user can still acquire additional features later on demand. This is possible due to the fact, that the necessary hardware for all features is always present.

Step 506 comprises selecting a predetermined period of time for which the feature is acquired as also described above with reference to FIG. 4. A feature (FoD) may be acquired for a finite period of time (for example, a trial period, which may be one week, or a specific period of time) or an unlimited period of time (for example, permanently). The predetermined period of time set, so that a feature may be acquired on a renewable basis (for example, the period may be set to a month so that renewal is acquired on a monthly basis). This is also advantageous when a specific feature (FoD) is only needed for a limited time, for example if a trip to another country with different radio systems is planned. The predetermined period of time may be selectable, for example a month, week or year. The period of time may also be dependent on the feature itself and may vary between different features (FoD).

Steps 502 to 506 may also be integrated within a radio operating menu in a vehicle.

For example, a menu item “DAB” is displayed with the note: “DAB can be acquired over FoD” . . . or “DAB MRC reception improvement can be acquired over FoD” . . . “do you like to activate one week trial subscription?” or if a customer in America, Asia or Africa wants to switch to the AM waveband, then it will be displayed: “AM Noise Cancellation can be acquired over FoD” . . . “do you like to activate one week trial subscription?”.

Step 508 comprises acquiring the selected features for the selected period of time. The user may for example tap on a “shopping cart” icon and discover all the selected features in the “FoD shopping cart” menu and use the OEM's ordering process to either buy a feature immediately for the life of the vehicle, for a certain period of time, or just the trial Activate subscription.

Step 510 comprises adding the selected period of time to a counter for the selected feature. For each feature a separate counter is assigned. Using this counter, it can be determined for how many individual time periods a feature has been acquired. For example, the DAB feature has been acquired 10 times, which may equal to 10 months. Alternatively, the counter can count the amount of money spent on a specific feature, that is summing up the monthly fees.

Step 512 comprises checking, for each feature, if the assigned counter exceeds a threshold. This threshold may be for example a number of times the feature has been acquired or a monetary value that for example matches the price for permanent acquisition. For example 20 times may be the equivalent for a permanent acquisition. This threshold may vary for each feature, so that for example the threshold for popular features may be higher. Or the threshold increases with growing popularity of a feature. To evaluate the popularity of a feature, feedback is sent to a reporting server 306. If, however, the counter for a specific feature exceeds its threshold, in step 514 the selected period of time is changed and the feature is acquired permanently. Step 516 then comprises activating the selected features in the SDR for the acquired period.

In an embodiment, the periods of time for a specific feature are summed up and when the sum exceeds a threshold, the feature is acquired permanently. Implementing such a capped fee may increase the acceptance of on demand acquisition of features. This threshold may be set to the fee for permanently acquiring a feature, a number of times a feature is acquired a certain period if times or any other value. The threshold may depend on the feature and vary between features.

In an embodiment a trial period can only be acquired once per feature. The trial period may be limited to a certain period of time, for example one or two weeks. In yet another embodiment, after improvements to a feature, e.g. after a software update over the air, or a significant change in the feature, a new trial period may be acquired. By this a customer can test the new and improved feature and decide that after the update the feature is now useful for him.

In an embodiment, the acquired features are reported to a central entity. This allows for detailed licensing payments to any third parties and also enables the manufacturer of a radio to evaluate success of any features. It also allows for evaluating a success or popularity of a feature. For this, for example a ratio between the overall number of trial periods and an overall number of acquired said features is monitored. This may give an idea of how many customers actually acquire a feature after testing it. If this ratio is high, then the feature is more popular.

In an embodiment activating the selected feature comprises enabling hardware in the tuner frontend part and/or enabling software parts of the SDR. For example a second radio tuner is activated in the tuner frontend in order to get diversity or background station list scanning. Features may also be deactivated when the acquired predetermined period of time ends.

In an embodiment the controller may activate a feature based on other parameters. For example, there may be a mood sensor in the vehicle. The mood sensor in the vehicle can be based on a machine learning algorithm or an artificial intelligence algorithm. It may then be possible to activate certain features in order to improve or heighten the mood of the customer. It also may be possible to present certain features as bonus or gift or compensation for past negative experiences with the vehicle. For example there may have been a problem in the garage in the past, so the customer is offered a feature as redress.

Additionally, features may be activated if statutory regulations change, so that all legal requirements are always met. For example, FM radio may be deactivated in a country and DAB becomes mandatory, then this specific feature can be activated, over the air, without further user input.

The shown methods only represent examples of how the inventive method may be implemented. Steps may be executed in a different order and may comprise additional steps and components.

1. A method for configuring a re-configurable multi-band multi-standard media receiver, the media receiver comprising a controller configured to control hardware components and software components of the media receiver, the method comprising:
selecting one or more features on demand, FoD of the multi-band multi-standard re-configurable media receiver; and
configuring the re-configurable media receiver based on the selected one or more FoD.

2. The method of claim 1, wherein configuring the re-configurable media receiver based on the selected one or more FoD comprises:
activating the selected one or more features of the re-configurable multi-band multi-standard media receiver, wherein activating the selected one or more features comprises activating a software component and/or a hardware component of the media receiver.

3. The method of claim 1, wherein a hardware component of the media receiver comprises:
one or more antennae,
one or more radio tuners,
one or more TV tuners, and/or
one or more digitizers; and
wherein a software component of the media receiver comprises:
one or more radio standards,
at least one service on demand, SoD,
an application programming interface, API,
a program, and/or
an algorithm.

4. The method of claim 1, wherein a FoD comprises:
a multistandard radio standard,
a multiband digital radio standard,
antenna diversity,
multi tuner,
AM noise reduction for EVs,
station list update,
seamless linking,
seamless blending, and/or
beam forming.

5. The method of claim 4, wherein the multi-band multi-standard media receiver comprises a software-defined radio algorithm, SDR, the method further comprising:
receiving, by the SDR, a hybrid signal comprising a digital broadcast signal and an analog broadcast signal;
determining, by the SDR, quantitative properties of the digital broadcast signal and the analog broadcast signal;
selecting, by the SDR, one of the digital broadcast signal and the analog broadcast signal based on the quantitative properties; and
subsequently selecting, by the SDR, the other one of the digital broadcast signal and the analog broadcast signal when the quantitative properties are reversed.

6. The method of claim 5, wherein the quantitative properties comprise:
a signal quality;
a signal strength;
a signal frequency property;
detection of the presence of a digital signal; and/or
detection of the presence of an analog signal.

7. The method of claim 5, wherein selecting and subsequently selecting the digital broadcast signal and the analog broadcast signal comprises:
switching between the broadcast signals via seamless linking or seamless blending.

8. The method of claim 1, wherein selecting a FoD comprises: presenting one or more FoD for selecting in a user interface of the media receiver.

9. The method of claim 1 further comprising:
detecting a location of the multi-band multi-standard media receiver;
determining at least one condition required by the location of the multi-band multi standard media receiver to activate one or more FoD; and
selecting the one or more FoD of the multi-band multi-standard media receiver that meet the at least one condition required by the location of the multi-band multi-standard media receiver.

10. The method of claim 2, wherein the selected FoD is acquired for a predetermined period of time, the method further comprising:
deactivating the selected one or more features of the re-configurable multi-band multi-standard media receiver;
re-activating the selected one or more features of the re-configurable multi-band multi-standard media receiver within the predetermined period of time; and
preventing re-activation of the selected one or more features of the re-configurable multi-band multi-standard media receiver outside of the predetermined period of time.

11. The method of claim 10, wherein the predetermined period of time is:
a finite period of time; or
an unlimited period of time.

12. A multi-band multi-standard re-configurable media receiver comprising a controller configured to carry out the method of claim 1.

13. The media receiver of claim 12, wherein the media receiver comprises a global navigation satellite system, GNSS, receiver operable to detect a location of the multi-band multi-standard media receiver, and wherein a FoD is selected depending the location of the media receiver.

14. The media receiver of any of claim 12, further comprising a software-defined radio algorithm, SDR, and/or wherein the controller is implemented as a software.

15. The media receiver of any of claim 12 further comprising a display unit, wherein the controller is configured to present FoDs on the display unit for selecting.
